(19) United States
(12) Patent Application Publication
(10) Pub. No.: US 2015/0118555 A1
(43) Pub. Date: Apr. 30, 2015

(54) ELECTRODE FOR LITHIUM-ION SECONDARY BATTERY, AND LITHIUM-ION SECONDARY BATTERY USING SAID ELECTRODE

(71) Applicant: MITSUBISHI MATERIALS CORPORATION, Tokyo (JP)

(72) Inventors: Jun Akikusa, Mito-shi (JP); Shigenari Yanagi, Toukai-mura (JP); Kenzo Nakamura, Toukai-mura (JP); Shin Tsuchiya, Saitama-shi (JP)

(73) Assignee: Mitsubishi Materials Corporation, Tokyo (JP)

(21) Appl. No.: 14/400,398

(22) PCT Filed: May 20, 2013
(86) PCT No.: PCT/JP2013/063891

§ 371 Date: Nov. 11, 2014

(30) Foreign Application Priority Data
May 31, 2012 (JP) 2012-124908

(51) Int. Cl. H01M 4/62; H01M 4/587; H01M 4/505; H01M 4/525; H01M 4/131; H01M 4/133

(52) U.S. Cl. CPC H01M 4/625; H01M 4/623; H01M 4/131; H01M 4/133; H01M 4/505; H01M 4/525; H01M 4/587; H01M 2004/028
USPC 429/217

(57) ABSTRACT

An electrode of a lithium-ion secondary battery includes: an electrode film that contains a conductive auxiliary agent, a binder and an active material; and an electrode foil, on a surface of which the electrode film is formed. The conductive auxiliary agent is carbon nano-fibers and the carbon nano-fibers are contained in the range of 0.1 to 3.0% by mass relative to 100% by mass of the electrode film. Further, when using an organic solvent as a solvent, 1.0 to 8.0% by mass of the binder excluding the organic solvent is contained. The active material is made of a mixed powder of a coarse particle powder having an average particle size of 1 to 20 μm and a fine particle powder having an average particle size of ⅓ to 1/10 of an average particle size of the coarse particle powder, and the porosity of the electrode film is 10 to 30%.

### TECHNICAL FIELD

The present invention relates to an electrode used in a lithium-ion secondary battery and a lithium-ion secondary battering using the electrode.

### BACKGROUND ART

A positive electrode formation material that includes particles of a positive electrode active material and fine carbon fibers adhered in mesh form on a surface of these particles of the positive electrode active material has been disclosed (see, Patent Document 1, for example). In the positive electrode formation material, the positive electrode active material is formed of fine particles having an average particle size of 0.03 μm to 40 μm. The fine carbon fibers are carbon nano-fibers having an average fiber diameter of 1 nm to 100 nm and an aspect ratio of 5 or more, and surfaces of these carbon nano-fibers are treated with an acid. A binder is further contained. A content of the fine carbon fibers is 0.5 to 15 parts by mass relative to 100 parts by mass of the positive electrode active material, and a content of the binder is 0.5 to 10 parts by mass. Further, the positive electrode active material is a lithium-containing transition metal oxide, and the lithium-containing transition metal oxide is at least one kind selected from the group consisting of LiCoO₂, LiNiO₂, LiMn₂O₄, LiMnCoO₄, LiCoPO₄, LiMnCrO₄, LiNiVO₄, LiMn_{1.5}Ni_{0.5}O₄, LiMnCrO₄, LiCoVO₄ and LiFePO₄.

In thus-configured positive electrode formation material, since a positive electrode in which carbon nano-fibers that are fine carbon fibers dispersed and adhered in mesh form on the particle surface of the positive electrode active material can be formed, with a relatively small amount of carbon fibers, the conductivity of the positive electrode can be improved, and an output of a battery can be improved thereby. Further, since the surface of the carbon nano-fibers that are the fine carbon fibers is acid treated and rendered hydrophilic, the carbon nano-fibers can be excellently dispersed in an aqueous solution. As a result, since there is no need of a dispersant, without gas generation due to decomposition of the dispersant, a positive electrode excellent in the output characteristics can be formed. Further, by using the carbon nano-fibers having an average fiber diameter of 1 nm to 100 nm and an aspect ratio of 5 or more as the fine carbon fibers relative to the positive electrode active material particles having an average particle size of 0.03 μm to 40 μm, a uniform mesh layer of the fine carbon fibers can be formed on the particle surfaces of the positive electrode active material, and with a small amount of carbon fibers, for example, a content of 0.5 to 15 parts by mass of the fine carbon fibers relative to 100 parts by mass of the positive electrode active material, a positive electrode having excellent conductivity can be obtained.

An electrode that includes a current collector and an active material layer formed on the current collector is disclosed, in which the active material layer includes an active material composition and a network structure, and the network structure includes carbon nano-tubes and a binder (see Patent Document 2, for example). In the electrode, carbon nano-tubes that form the network structure are electrically connected each other. Further, a content of the carbon nano-tubes is 0.01 to 20% by mass of a total weight of the active material layer. Further, as the active material, a Li—Co based metal oxide such as LiCoO₂, a Li—Ni based metal oxide such as LiNiO₂, a Li—Mn based metal oxide such as LiMn₂O₄ or LiMnO₂, a Li—Cr based metal oxide such as Li₂Cr₂O₇ or Li₂CrO₄, and a Li—Fe based phosphate such as LiFePO₄ can be used.

In thus structured electrode, the network structure has a mesh form, is contained inside of the active material layer, and assumes a role of one kind of skeleton. That is, the carbon nano-tubes are three-dimensionally disposed and electrically connected with each other, and the binder connects the carbon nano-tubes with each other. Thus, since the carbon nano-tubes form a conductive network in the network structure, the network structure can be assumed as a conductive material. Further, since a three-dimensional arrangement of the carbon nano-tubes is held by the binder, the network structure assumes a role of a support table that prevents a volume change of the active material during charging and discharging. Therefore, without using the conductive material and the binder excessively in the active material layer, an electric potential of the active material layer can uniformly be maintained, the active material layer is prevented from being cracked during charging and discharging, as a result, the cycle characteristics of the battery can be improved.

### PRIOR ART REFERENCES

### Patent Documents

Patent Document 1: Japanese Unexamined Patent Application Publication No. 2008-270204 (claims 1 to 3, 6 and 7, Paragraphs [0010] and [0011])

Patent Document 2: Japanese Unexamined Patent Application Publication No. 2009-170410 (claims 1, 3 and 7, Paragraph [0011] and [0036])

### SUMMARY OF THE INVENTION

### Problems to be Solved by the Invention

According to the positive electrode formation material shown in the conventional Patent Document 1 described above, an average particle size of the positive active material is 0.03 μm to 40 μm, and according to the electrode shown in the conventional Patent Document 2, an average particle size of the active material composition is not particularly defined, and it is considered that the active material composition having a general average particle size is used. However, when the active materials having general particle sizes are optionally mixed as the active material, there was a problem that a battery capacity per volume could not be increased.

A first object of the present invention is to provide an electrode of a lithium-ion secondary battery, which uses, not carbon black having low bulk density, but only carbon nano-fibers having high bulk density as a conductive auxiliary agent, an active material made of a mixed powder of a coarse particle powder and a fine particle powder, and can increase a discharging capacity per unit volume; and a lithium-ion secondary battery using the same. A second object of the present invention is to provide an electrode of a lithium-ion secondary battery, which can obtain excellent conductivity by setting the porosity to 10 to 30%; and a lithium-ion secondary battery using the same.

### Means for Solving the Problems

According to a first aspect of the present invention, in an electrode of a lithium-ion secondary battery, in which an electrode film that includes a conductive auxiliary agent, a binder and an active material is formed on an electrode foil, when the conductive auxiliary agent is carbon nano-fibers, 0.1 to 3.0% by mass of the carbon nano-fibers is contained in relative to 100% by mass of the electrode film, and the binder uses an organic solvent as a solvent, the electrode is characterized in that the binder excluding the organic solvent is contained in the range of 1.0 to 8.0% by mass relative to 100% by mass of the electrode film, the active material is contained at a remaining percentage, the active material is made of a mixed powder of a coarse particle powder having an average particle size of 1 to 20 μm and a fine particle powder having an average particle size of ⅓ to 1/10 of the average particle size of the coarse particle powder, and the porosity of the electrode film is 10 to 30%.

A second aspect of the present invention, which is an invention based on the first aspect is characterized further in that the binder is polyvinylidene fluoride that uses an organic solvent as a solvent.

A third aspect of the present invention, which is an invention based on the first aspect is characterized further in that an active material is a positive electrode active material made of any one of LiCoO₂, LiMn₂O₄, LiNiO₂, LiFePO₄ or Li(MnₓNi_{y}Co_{z})O₂. Herein, X, Y and Z in Li(MnₓNi_{y}Co_{z})O₂ satisfies a relationship of X+Y+Z=1 and satisfies a relationship of 0<X<1, 0<Y<1 and 0<Z<1.

A fourth aspect of the present invention, which is an invention based on the first aspect is characterized further in that the active material is a negative electrode active material made of graphite.

A fifth aspect of the present invention relates to a lithium-ion secondary battery that uses the electrode described in the first aspect.

### Effects of the Invention

According to the electrode of the first aspect of the present invention, since, without utterly using particulate carbon black having low bulk density, the active material made of a mixed powder of a coarse particle powder and a fine particle powder is bonded with fibrous carbon nano-fibers, the active material made of a fine particle powder penetrates between active materials made of the coarse particle powder and, between the active materials, carbon nano-fibers having high bulk density and excellent conductivity penetrate, and an electrical network is densified thereby. Thus, since an electrical network from the active material to an electrode foil (current collector) via the carbon nano-fibers is densified, a discharging capacity per unit volume of the electrode can be increased. Further, since the porosity of the electrode film is set to a small value such as 10 to 30%, the electrical network can further be densified. As a result thereof, since an electrical network from the active material to the electrode foil (current collector) via the carbon nano-fibers is further densified, the conductivity of the electrode becomes excellent and the battery performance can be improved.

### BRIEF DESCRIPTION OF THE DRAWINGS

FIG. 1 is a photographic image of a part of a cross-section of a positive electrode according to Example 2 of the present invention, which was taken with a scanning electron microscope (SEM);

FIG. 2 is a photographic image of a part of a cross-section of a positive electrode according to Comparative Example 3, which was taken with a scanning electron microscope (SEM); and

FIG. 3 is a photographic image of a part of a cross-section of a positive electrode according to Comparative Example 4, which was taken with a scanning electron microscope (SEM).

### BEST MODES FOR CARRYING OUT THE INVENTION

Next, a mode for carrying out the present invention will be described. An electrode of a lithium-ion secondary battery includes an electrode film containing a conductive auxiliary agent, a binder and an active material, and an electrode foil on a surface of which the electrode film is formed. The conductive auxiliary agent is carbon nano-fibers and the carbon nano-fibers include carbon nano-tubes. The carbon nano-fibers preferably have an average fiber outer diameter of 5 to 25 nm, an average length of 0.1 to 10 μm, and a specific surface area of 100 to 500 m²/g. Here, the reason why the average fiber outer diameter of the carbon nano-fibers is limited to within the range of 5 to 25 nm is because, in the case of less than 5 nm, electronic conductivity of the carbon nano-fibers decreases, and in the case of exceeding 25 nm, the characteristics by which the carbon nano-fibers tangle with the active material are degraded. Further, the reason why the average length of the carbon nano-fibers is limited to within the range of 0.1 to 10 μm is because, in the case of less than 0.1 μm, it is too short as a length of the carbon nano-fiber that assumes a cross-linking role between active materials, and in the case of exceeding 10 μm, aggregation tends to occur. Further, the reason why the specific surface area of the carbon nano-fibers is limited to within the range of 100 to 500 m²/g is because, in the case of less than 100 m²/g, the viscosity during preparation of an electrode paste becomes too low, and in the case of exceeding 500 m²/g, the viscosity during preparation of the electrode paste becomes too high.

As the binder, polyvinylidene fluoride (PVDF) that uses an organic solvent as a solvent can be cited. When the binder is polyvinylidene fluoride, an organic solvent such as N-methylpyrrolidone (NMP) or the like can be used as a solvent. The organic solvent vaporizes during drying and does not remain in the electrode.

On the other hand, as the active material, in the case where the electrode is a positive electrode, a positive electrode active material made of any one of LiCoO₂, LiMn₂O₄, LiNiO₂, LiFePO₄ or Li(MnₓNi_{y}Co_{z})O₂ can be cited, and in the case where the electrode is a negative electrode, a negative electrode active material made of graphite such as natural graphite or artificial graphite can be cited. However, X, Y and Z in Li(MnₓNi_{y}Co_{z})O₂ satisfy a relationship of X+Y+Z=1 and satisfy a relationship of 0<X<1, 0<Y<1 and 0<Z<1. Further, the active material is made of a mixed powder of a coarse particle powder having an average particle size of 1 to 20 μm, preferably 1 to 10 μm, and a fine particle powder having an average particle size of ⅓ to 1/10, preferably ¼ to 1/7 of the average particle size of the coarse particle powder. Further, the coarse particle powder and the fine particle powder are preferable to be mixed at a mixing ratio of the coarse particle powder and the fine particle powder, that is, (coarse particle powder: fine particle powder) in the range of (77:23) to (50:50) by mass ratio. Here, the reason why the average particle size of the coarse particle powder of the active material is limited to within the range of 1 to 20 μm is because, in the case of less than 1 μm, the compatibility with the fine particle powder becomes poor, and in the case of exceeding 20 μm, irregularity of a surface of the electrode film formed on the electrode foil becomes larger. Further, the reason why an average particle size of the fine particle powder of the active material is limited to within the range of ⅓ to 1/10 of the average particle size of the coarse particle powder is because, in the case of less than 1/10, an amount of the binder adhered to the surface of the fine particle powder excessively large, and in the case of exceeding ⅓, the active material cannot be effectively packed in a combination with the coarse particle powder. Further, the reason why the (coarse particle powder: fine particle powder) is limited to within the range of (77:23) to (50:50) by mass ratio is because when the fine particle powder is less than 23% by mass, the fine particle powder is not sufficiently present between the coarse particle powders, and when the fine particle powder exceeds 50% by mass, bonds between the fine particle powders excessively increase due to a large amount of the fine particle powder, the electrolytic solution that soaks in the electrode becomes less, and lithium ions in the electrolytic solution are disturbed from migrating. This is a phenomenon that occurs also when only the fine particle powder is used as the active material.

The average particle size of the coarse particle powder of the active material and the average particle size of the fine particle powder of the active material are obtained in the following manner. That is, each of the active materials is dispersed in an NMP solvent (N-methylpyrrolidone solvent) at 20° C. so as to be 3% by mass as a solution and measured with IG-1000 (Single Nanoparticle Size Analyzer manufactured by Shimadzu Corporation), and each of volume average values is taken as an average particle size of the coarse particle powder of the active material and an average particle size of the fine particle powder of the active material. Further, the average fiber outer diameter and the average length of the carbon nano-fibers are measured in the following manner that the outer diameters and the lengths of 30 carbon nano-fibers are measured with a transmission electron microscope (TEM), and average values thereof are taken as the average fiber outer diameter and the average length of the carbon nano-fibers.

By contrast, when polyvinylidene fluoride that uses an organic solvent as a solvent is used as the binder, mixing ratios of the carbon nano-fibers, the binder and the active material are 0.1 to 3.0% by mass, 1.0 to 8.0% by mass, and the balance when the electrode film (a total amount of the electrode paste excluding the organic solvent) is set to 100% by mass. The organic solvent is preferably mixed at a ratio of 30 to 60% by mass, when the electrode film (a total amount of the electrode paste excluding the organic solvent) is set to 100% by mass. The reason why the mixing ratio of the carbon nano-fibers is limited to within the range of 0.1 to 3.0% by mass is because, in the case of less than 0.1% by mass, entanglement of the carbon nano-fibers with the active material decrease, and in the case of exceeding 3.0% by mass, the carbon nano-fibers tangle with each other and the carbon nano-fibers aggregate. Further, the reason why the mixing ratio of the binder is limited to within the range of 1.0 to 8.0% by mass is because in the case of less than 1.0% by mass, adhesiveness between the active material and the current collector becomes weaker, and in the case of exceeding 8.0% by mass, a content ratio of polyvinylidene fluoride that hardly has the electronic conductivity increases and electric conduction is degraded. Further, the reason why the mixing ratio of the organic solvent is limited to within the range of 30 to 60% by mass is because, in the case of less than 30% by mass, the viscosity of the electrode paste becomes too high to be capable of coating the electrode paste, and in the case of exceeding 60% by mass, the viscosity of the electrode paste becomes too low to be capable of coating the paste for the electrode.

A first method of preparing a paste (electrode paste) that is used to prepare thus structured electrode will be described. First, by adding a solvent or a thickener to a binder, a binder paste having the viscosity is prepared. When polyvinylidene fluoride that uses an organic solvent as a solvent is used as the binder, an organic solvent such as N-methylpyrrolidone or the like is added. A solid binder is dissolved in the organic solvent and the binder paste having viscosity is formed thereby. Further, when styrene-butadiene rubber that uses water as a solvent is used as the binder, the thickener such as carboxymethylcellulose or the like is added. Thus, the viscosity is imparted to the binder, and the binder paste having viscosity is formed. Next, in the binder paste, powders of carbon nano-fibers and active material are simultaneously added, after stirring with a mixer that does not apply a shearing force to the respective powders, the mixture is further stirred with a homogenizer that does not apply a shearing force to the respective powders, and the respective powders are dispersed in the binder paste. Further, the respective powders dispersed in the binder paste are stirred with a homogenizer that can apply a shearing force, aggregates of the respective powders remaining in the binder paste are dispersed, and the electrode paste is prepared thereby. Thus, the carbon nano-fibers adhere to a majority and an entirety of the surface of the active material and are fixed with the binder. As a result, since the carbon nano-fibers electrically crosslink the active materials, very excellent electrical paths are formed in the electrode and the performance of the battery can be improved thereby.

The mixer that does not apply a shearing force to the respective powders means a stirrer that simultaneously stirs and deaerates with two centrifugal forces of rotation and revolution and uniformly disperses the respective powders in the binder paste without shearing the respective powders such as Awatori Rentarou (product name of a mixer manufactured by Thinky Corporation). Further, the homogenizer includes a cylindrical stationary outer blade provided with a plurality of windows and a plate-like rotary inner blade that rotates in the stationary outer blade. When the rotary inner blade is rotated at a high-speed in the binder paste, at the same time with vigorously ejecting the paste in the stationary outer blade radially from the windows by the centrifugal force, the paste infiltrates into the stationary outer blade from an open end surface of the stationary outer blade and generates a powerful convection, the respective powders infiltrate in the convection, and the respective powders are dispersed into the paste and pulverized. The homogenizer that does not apply a shearing force to the respective powders means a homogenizer that performs only dispersion without shearing the powder by relatively expanding a gap between the stationary outer blade and the rotary inner blade. Further, the homogenizer that applies a shearing force to the respective powders means a homogenizer that disperses the powder by relatively narrowing a gap between the stationary outer blade and the rotary inner blade, and, at the same time, pulverizes the aggregates of the powder by shearing between the stationary outer blade and the rotary inner blade.

Next, a second method of preparing an electrode paste will be described. First, the carbon nano-fibers, the binder and the active material are stirred in a state of powder with a planetary mixer and a mixed powder is prepared. Next, the mixed powder is stirred with the planetary mixer while adding a solvent little by little therein to dissolve the binder in the solvent, and the electrode paste in which the respective powders of the active material and the carbon nano-fibers are uniformly dispersed is prepared thereby. Thus, the carbon nano-fibers adhere to a majority and an entirety of a surface of the active material and fixed by the binder. As the result thereof, since the carbon nano-fibers electrically crosslink the active materials each other, very excellent electrical paths are formed in the electrode, and the performance of the battery can be improved. The planetary mixer includes a tank and two frame blades that rotate in the tank. Due to a planetary movement of the blade, a dead space between blades and a dead space between the blades and an inner surface of the tank are very slight, and a strong shearing force works on the respective powders in the binder paste. Thus, the powders are dispersed and the aggregates of the powder are pulverized by the shearing force. Further, the carbon nano-fibers, the binder, the active material and soon are mixed at the same ratio as that of the first method.

A method of preparing an electrode with thus prepared electrode paste will be described. First, by coating the electrode paste prepared according to the method described above on an electrode foil (current collector), an electrode film is formed on the electrode foil. Herein, when the electrode is a positive electrode, an aluminum foil is used as the electrode foil, and when the electrode is a negative electrode, a copper foil is used as the electrode foil. Next, by using an applicator having a gap of about 50 μm, the electrode film is formed into a definite thickness. Then, the electrode foil having the electrode film having a definite thickness is put into a dryer, held at 100 to 140° C. for 5 minutes to 2 hours to evaporate the organic solvent or moisture, and the electrode film is dried thereby. Further, the dried electrode film is compressed by a press machine such that the porosity is 10 to 30%, preferably 18 to 28%, and a sheet-like electrode is prepared thereby. Herein, the reason why a drying temperature of the electrode film is limited to within the range of 100 to 140° C. is because in the case of less than 100° C., a drying time becomes longer, and in the case of exceeding 140° C., the polyvinylidene fluoride is pyrolyzed. Further, the reason why the drying time of the electrode film is limited to within the range of 5 minutes to 2 hours is because in the case of less than 5 minutes, the electrode film is insufficiently dried, and in the case of exceeding 2 hours, the electrode film is excessively solidified. Still further, the reason why the porosity of the electrode film is limited to within the range of 10 to 30% is because in the case of less than 10%, the electrolytic solution is difficult to infiltrate in the electrode film, and in the case of exceeding 30%, a spatial volume becomes excessively large, and a battery capacity per unit volume decreases.

In thus-manufactured electrode, since, as the conductive auxiliary agent, the particulate carbon black that is low in the bulk density are not utterly used, but the fibrous carbon nano-fibers are used to bind the active material made of the mixed powder of the coarse particle powder and fine particle powder, the active material made of the fine particle powder infiltrate between the active materials made of the coarse particle powder, the electrode film is densified, further, the carbon nano-fibers that are high in the bulk density infiltrate between these active materials, and the electrode film is further densified thereby. As a result, since the electrical network from the active material via the carbon nano-fibers to the electrode foil (current collector) is densified, the discharging capacity per unit volume of the electrode can be increased. Further, since the porosity of the electrode film is set such small as 10 to 30%, the electrode film is further densified. As a result, since the electrical network from the active material via the carbon nano-fibers to the electrode foil (current collector) is further densified, the conductivity of the electrode becomes excellent and the battery performance can be improved.

### EXAMPLES

Next, Examples of the present invention will be described in detail together with Comparative Examples.

### Example 1

In advance, as a positive electrode active material (LiFePO₄ (LFP)), a mixed powder was prepared by mixing a coarse particle powder having an average particle size of 1.5 μm and a fine particle powder (fine particle powder having an average particle size of 0.2 μm) having an average particle size of 1/7.5 of the average particle size of the coarse particle powder such that the fine particle powder is 50% by mass relative to 50% by mass of the coarse particle powder. First, in polyvinylidene fluoride (PVDF) that is a binder that uses an organic solvent as a solvent, N-methylpyrrolidone (NMP) that is an organic solvent is added, and a binder paste having viscosity was prepared thereby. In the binder paste, the respective powders of the carbon nano-fibers (CNF) and the positive electrode active material (LiFePO₄ (LFP)) described above were simultaneously added, and, after stirring with Awatori Rentarou (product name of a mixer manufactured by Thinky Corporation) for 5 minutes, the mixture was further stirred for 5 minutes with a homogenizer that does not apply a shearing force to the respective powders. Then, the mixture was stirred with a homogenizer that applies a shearing force to the respective powders dispersed in the binder paste, and the electrode paste was prepared. Herein, mixing ratios of the carbon nano-fibers (CNF), the polyvinylidene fluoride (PVDF), and the positive electrode active material (LiFePO₄ (LFP)) were 2% by mass, 5% by mass, and 93% by mass when the electrode film (a total amount of the electrode paste excluding the organic solvent) was set to 100% by mass. Then, the electrode paste described above was coated on an aluminum foil (current collector) and the electrode film was formed on the aluminum foil. Next, by using an applicator having a gap of 50 μm, the electrode film was formed into a definite thickness. The electrode foil having the electrode film having a definite thickness was charged into a dryer, held at 130° C. for 1 hour to evaporate the organic solvent and to dry the electrode film, and a sheet-like electrode was prepared. Further, the sheet-like electrode was, after cutting into a square plate of 10 cm in height and width, compressed with a press machine, and a positive electrode was prepared thereby. The positive electrode was taken as Example 1. The porosity of the electrode film on the electrode foil was 23%. Further, (LiFePO₄ (LFP)) manufactured by TATUNG FINE CHEMICAL CO. was used, as the polyvinylidene fluoride, #1100 (product No.) manufactured by Kureha Battery Materials Japan Co., Ltd., was used, and as the carbon nano-fibers (CNF), MDCNF (product name) manufactured by MD Nanotech Corporation was used (hereinafter, the same in “EXAMPLE”).

The porosity K described above was obtained as follows. A theoretical thickness A (cm) of the electrode film when the porosity is zero is a sum total of a value obtained by totaling a value obtained by dividing an amount of the active material per unit area of the electrode film (g/cm²) with the density of the active material (g/cm³), a value obtained by dividing an amount of binder per unit area of the electrode film (g/cm²) with the density of the binder (g/cm³), and a value obtained by dividing an amount of the conductive auxiliary agent per unit area of the electrode film (g/cm²) with the density of the conductive auxiliary agent (g/cm³). Here, from the mixing ratios of the active material, the binder and the conductive auxiliary agent, masses of the respective components per unit area can be calculated. On the other hand, when a cross-sectional thickness of the electrode film due to an electron microscope is set to B (cm), a packing rate P (%) of the electrode film is represented by [(A/B)×100]. Therefore, the porosity K (%) of the electrode film can be obtained from [100-P].

### Comparative Example 1

A positive electrode was prepared in advance in the same manner as Example 1 except that the positive electrode active material (LiFePO₄ (LFP)) made of only a fine particle powder having an average particle size of 0.2 μm was prepared. The positive electrode was taken as Comparative Example 1. The porosity of the electrode film on the electrode foil was 20%.

### Comparative Example 2

A positive electrode was prepared in the same manner as Example 1 except that the positive electrode active material (LiFePO₄ (LFP)) made of only a coarse particle powder having an average particle size of 1.5 μm was prepared in advance. The positive electrode was taken as Comparative Example 1. The porosity of the electrode film on the electrode foil was 31%.

<Comparison Test 1 and Evaluation>

With each of the positive electrodes of Example 1, Comparative Example 1 and Comparative Example 2, a lithium-ion secondary battery was prepared, and a 5 C discharging capacity was measured. Specifically, first, by cutting a lithium plate having a thickness of 0.25 mm into a square plate of 10 cm in width and height, a counter electrode (or negative electrode) was prepared. Next, a separator having a laminate structure in which a polyethylene sheet is sandwiched with two polypropylene sheets was cut into a size larger than the positive electrode. Then, this separator was sandwiched with the positive electrode and the counter electrode. Further, as an electrolytic solution, a liquid (1M-LiPF₆ solution (manufactured by Ube Industries, Ltd.)) that is obtained by dissolving lithium hexafluorophosphate at a concentration of 1M in a solvent in which ethylene carbonate (EC: ethylene carbonate) and diethyl carbonate (DEC: diethyl carbonate) were mixed at a mass ratio of 1:1 was used. The electrolytic solution was, after infiltrating in the separator and the electrode films on the electrode foil, housed in an aluminum laminate film, and a lithium-ion secondary battery was prepared thereby.

Each of a pair of lead wires was connected to the positive electrode and the negative electrode of the lithium-ion secondary battery described above, and, a charging and discharging cycle test was performed, and a 5 C discharging capacity after 300 cycles was measured. Specifically, a charging was performed under condition of a constant rate of 0.2 C and a voltage of 3.6 V according to a CC-CV method (constant current-constant voltage method) and discharging was performed under a constant rate of 5 C according to a CC method (constant current method). Here, the “C rate” means a charging and discharging rate, a current amount that discharges a total capacity of the battery in one hour is called as a 1 C rate charging and discharging, and when an amount of current is for example 2 times the amount of current, it is called a 2 C rate charging and discharging. A measurement temperature at this time was set constant at 25° C. A cut-off voltage during discharging was set constant at 2.0 V, and when decreasing to this potential, without waiting for a predetermined time of the C rate, the measurement was stopped. Results thereof are shown in the following Table 1.

TABLE 1

| | Conductive auxiliary | | | | |
|---|---|---|---|---|---|
| | agent | | | Porosity | |
| | | Coarse | Fine | of | 5 C |
| | | particle | particle | positive | discharging |
| | | powder | powder | electrode | capacity |
| | Kind | (μm) | (μm) | (%) | (mAh/g) |
| Example 1 | CNF | 1.5 | 0.2 | 23 | 124 |
| Comparative | CNF | None | 0.2 | 20 | 58 |
| Example 1 | | | | | |
| Comparative | CNF | 1.5 | None | 31 | 60 |
| Example 2 | | | | | |

As obvious from Table 1, while in Comparative Example 1 in which only the fine particle powder was used as the positive electrode active material, the 5 C discharging capacity was such low as 58 mAh/g, and in Comparative Example 2 in which only the coarse particle powder was used as the positive electrode active material, the 5 C discharging capacity was such low as 60 mAh/g, in Example 1 in which a mixed powder of the coarse particle powder and the fine particle powder was used as the positive electrode active material, the 5 C discharging capacity became remarkably high such as 124 mAh/g. Here, the reason why, in Comparative Example 1, the 5 C discharging capacity became such low as 58 mAh/g is considered that because although a thickness of the positive electrode became thin since the porosity of the positive electrode was lower than the general porosity (30%), since a volume in which the electrolytic solution infiltrates and is held decreased, the migration of the lithium ions in the electrolytic solution was degraded. Further, the reason why the 5 C discharging capacity became such low as 60 mAh/g in Comparative Example 2 is considered because since the particle size of the coarse particle powder was large, the positive electrode did not become thin, the porosity of the positive electrode (31%) was nearly equal with the general porosity (30%), and relatively large gaps were present in a relatively large amount between the positive electrode active materials having a large particle size, even when the carbon nano-fibers (CNF) were added, the electrical conductive paths were formed less between the positive electrode active materials, and the contact resistance between the positive electrode active materials increased. On the other hand, the reason why the 5 C discharging capacity became such high as 124 mAh/g in Example 1 is considered because by mixing the fine particle powder and the coarse particle powder, the active material made of the fine particle powder infiltrated between the active materials made of the coarse particle powder, and the carbon nano-fibers having large bulk density and excellent conductivity infiltrated between these active materials, the electrical network was densified, and the discharging capacity per unit volume of the electrode increased thereby.

### Example 2

A positive electrode was prepared in the same manner as Example 1 except that mixing ratios of the carbon nano-fibers (CNF), the polyvinylidene fluoride (PVDF) and the positive electrode active material (LiFePO₄ (LFP)) were changed to 3% by mass, 5% by mass, and 92% by mass when the electrode film (a total amount of the electrode paste excluding the organic solvent) was set to 100% by mass. This positive electrode was taken as Example 2. The porosity of the electrode film on the electrode foil was 25%.

### Comparative Example 3

A positive electrode was prepared in the same manner as Example 1 except that mixing ratios of acetylene black (AB), carbon nano-fibers (CNF), polyvinylidene fluoride (PVDF) and positive electrode active material (LiFePO₄ (LFP)) were set to 5% by mass, 3% by mass, 5% by mass, and 87% by mass when the electrode film (a total amount of the electrode paste excluding the organic solvent) was set to 100% by mass. This positive electrode was taken as Comparative Example 3. The porosity of the electrode film on the electrode foil was 25%. Further, the acetylene black (AB) is one kind of carbon black, and an average particle size of the acetylene black was 50 to 100 nm. Further, as the acetylene black, a powdery product of acetylene black manufactured by DENKI KAGAKU KOGYO KABUSHIKI KAISHA was used (hereinafter, the same in [Example].).

### Comparative Example 4

A positive electrode was prepared in the same manner as Example 1 except that mixing ratios of acetylene black (AB), carbon nano-fibers (CNF), polyvinylidene fluoride (PVDF) and a positive electrode active material (LiFePO₄ (LFP)) were set to 5% by mass, 0% by mass, 5% by mass, and 90% by mass when the electrode film (a total amount of the electrode paste excluding the organic solvent) was set to 100% by mass. This positive electrode was taken as Comparative Example 4. The porosity of the electrode film on the electrode foil was 25%. Further, the acetylene black had an average particle size of 50 to 100 nm.

<Comparison Test 2 and Evaluation>

With the positive electrodes of Example 2, Comparative Example 3 and Comparative Example 4, in the same manner as Comparative Example 1, lithium-ion secondary batteries were prepared and the 5 C discharging capacities were measured. Further, volume change rates of the positive electrodes of Example 2, Comparative Example 3 and Comparative Example 4 were measured. As the volume change rate, in the positive electrode of Comparative Example 3 that contains 5% by mass of acetylene black (AB) and 3% by mass of carbon nano-fibers (CNF), when a thickness of the positive electrode when the discharging capacity per unit area (1 cm²) is set constant is set to 100%, decrease ratios of the thicknesses of the positive electrodes of Example 2 and Comparative Example 4 were obtained. Specifically, a volume X₁ of the electrode film was calculated from a thickness of the electrode film per unit area (per 1 cm²), which 3% by mass of carbon nano-fibers (CNF), 5% by mass of polyvinylidene fluoride (PVDF) and 92% by mass of positive electrode active material (LiFePO₄ (LFP)) occupy, a volume X₂ of the electrode film was calculated from a thickness of the electrode film per unit area (per 1 cm²), which 5% by mass of acetylene black (AB), 3% by mass of carbon nano-fibers (CNF), 5% by mass of polyvinylidene fluoride (PVDF) and 87% by mass of positive electrode active material (LiFePO₄ (LFP)) occupy, and a volume change rate V (%) was obtained from the following formula (1).

V=(X₁/X₂)×100 (1)

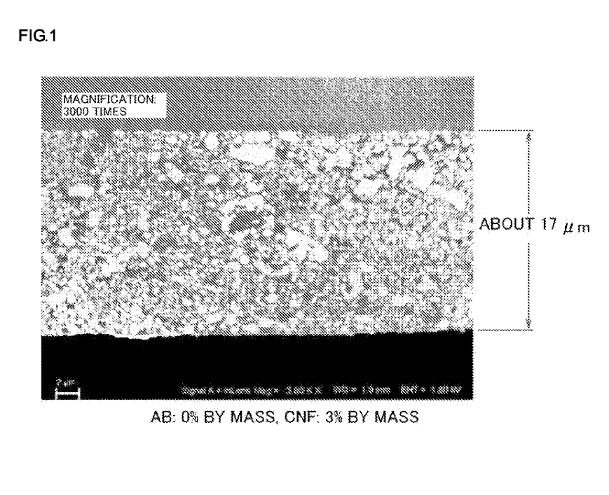

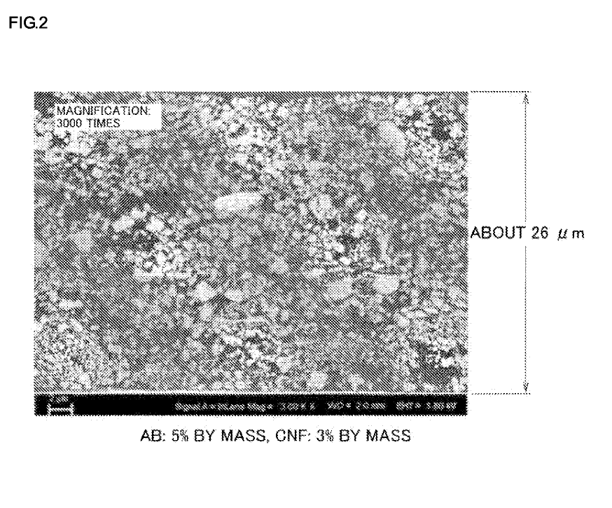

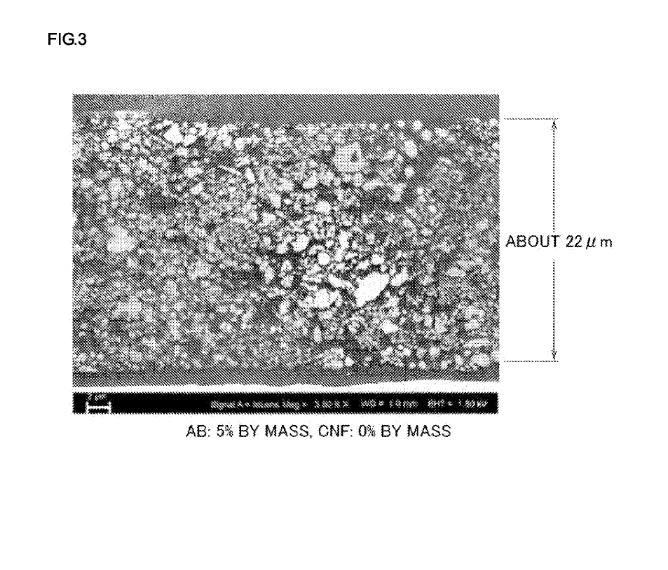

Results thereof are shown in Table 2. Further, a photographic image in which a part of a cross-section of the positive electrode of Example 2 was taken with a scanning electron microscope (SEM) is shown in FIG. 1, a photographic image in which a part of a cross-section of the positive electrode of Comparative Example 3 was taken with a scanning electron microscope (SEM) is shown in FIG. 2, and a photographic image in which a part of a cross-section of the positive electrode of Comparative Example 4 was taken with a scanning electron microscope (SEM) is shown in FIG. 3.

TABLE 2

| | Conductive | | | Positive electrode | Porosity | | |
|---|---|---|---|---|---|---|---|
| | auxiliary agent | | Binder | active material | of | 5 C | Volume |
| | AB | CNF | PVDF | LiFePO₄ | positive | discharging | change |
| | (% by | (% by | (% by | (LFP) (% by | electrode | capacity | rate |
| | mass) | mass) | mass) | mass) | (%) | (mAh/g) | (%) |
| Example 2 | 0 | 3 | 5 | 92 | 25 | 121 | 71 |
| Comparative | 5 | 3 | 5 | 87 | 25 | 97 | 100 |
| Example 3 | | | | | | | |
| Comparative | 5 | 0 | 5 | 90 | 25 | 61 | 85 |
| Example 3 | | | | | | | |

As obvious from Table 2, while, in Comparative Example 3 in which a mixed powder of acetylene black (AB) and carbon nano-fibers was used as the conductive auxiliary agent, the 5 C discharging capacity was such low as 97 mAh/g, and in Comparative Example 4 in which only acetylene black (AB) was used as the conductive auxiliary agent, the 5 C discharging capacity was further such low as 61 mAh/g, in Example 2 in which only carbon nano-fibers were used as the conductive auxiliary agent, the 5 C discharging capacity became such high as 121 mAh/g. From this, it was found that there is a tendency that when the acetylene black is not used as the conductive auxiliary agent, the volume of the positive electrode decrease and the discharging capacity increases. This is considered that while, in Comparative Examples 3 and 4, as shown in FIG. 2 and FIG. 3, since 5% by mass of acetylene black (AB) had an angular polygonal shape having an average particle size of 50 to 100 nm and were relatively bulky, the volume of the positive electrode increased, in Example 2, as shown in FIG. 1, although 3% by mass of the carbon nano-fibers (CNF) were contained, since the acetylene black was not contained, the density of the positive electrode active material in the positive electrode increased, and excellently packed positive electrode structure was formed. It is considered that since the carbon nano-fibers (CNF) are fibrous, without being bulky, a role of binding LiFePO₄ (LFP) that is the positive electrode active material is performed.

### Example 3

A positive electrode was prepared in the same manner as Example 1 except that LiCoO₂ (LCO) was used as the positive electrode active material, this positive electrode active material was made of a mixed powder in which a coarse particle powder having an average particle size of 14 μm and a fine particle powder (fine particle powder having an average particle size of 4 μm) having an average particle size of 1/3.5 of the average particle size of the coarse particle powder were mixed such that the fine particle powder is 50% by mass relative to 50% by mass of the coarse particle powder, and mixing ratios of carbon nano-fibers (CNF), polyvinylidene fluoride (PVDF) and a positive electrode active material (LiCoO₂ (LCO)) were set to 3% by mass, 5% by mass, and 92% by mass when the electrode film (a total amount of the electrode paste excluding the organic solvent) was set to 100% by mass. The positive electrode was taken as Example 3. The porosity of the electrode film on the electrode foil was 29%. Further, as LiCoO₂ (LCO), C-10N (product number) manufactured by Nippon Chemical Industrial Co., LTD. was used (hereinafter, the same in [Example]).

### Comparative Example 5

A positive electrode was prepared in the same manner as Example 1 except that LiCoO₂ (LCO) was used as the positive electrode active material, this positive electrode active material was made of a mixed powder in which a coarse particle powder having an average particle size of 14 μm and a fine particle powder (fine particle powder having an average particle size of 4 μm) having an average particle size of 1/3.5 of the average particle size of the coarse particle powder were mixed such that the fine particle powder is 50% by mass relative to 50% by mass of the coarse particle powder, and mixing ratios of acetylene black (AB), carbon nano-fibers (CNF), polyvinylidene fluoride (PVDF) and a positive electrode active material (LiCoO₂ (LCO)) were set to 5% by mass, 3% by mass, 5% by mass, and 87% by mass when the electrode film (a total amount of the electrode paste excluding the organic solvent) was set to 100% by mass. The positive electrode was taken as Comparative Example 5. The porosity of the electrode film on the electrode foil was 29%.

<Comparison Test and Evaluation>

With the positive electrodes of Example 3 and Comparative Example 5, in the same manner as Comparison Test 1, lithium-ion secondary batteries were prepared and the 5 C discharging capacities were measured, and the volume change rates were obtained in the same manner as Comparison Test 2. These results are shown in Table 3. In order to make comparison due to the difference of the kinds of the positive electrode active materials easy, in Table 3, also data of Example 2 was described.

TABLE 3

| | Conductive | | | Positive electrode | | | | |
|---|---|---|---|---|---|---|---|---|
| | auxiliary agent | | Binder | active material | | | 5 C | Volume |
| | AB | CNF | PVDF | | Content ratio | | discharging | change |
| | (% by | (% by | (% by | | (% by | Porosity | capacity | rate |
| | mass) | mass) | mass) | Kind | mass) | (%) | (mAh/g) | (%) |
| Example 2 | 0 | 3 | 5 | LiFePO₄ | 92 | 25 | 121 | 71 |
| | | | | (LFP) | | | | |
| Example 3 | 0 | 3 | 5 | LiCoO₂ | 92 | 29 | 141 | 86 |
| | | | | (LCO) | | | | |
| Comparative | 5 | 3 | 5 | LiCoO₂ | 87 | 29 | 95 | 100 |
| Example 5 | | | | (LCO) | | | | |

As obvious from Table 3, while, in Comparative Example 5 in which a mixed powder of acetylene black (AB) and carbon nano-fibers was used as the conductive auxiliary agent, the 5 C discharging capacity was such low as 95 mAh/g, the 5 C discharging capacity of Example 3 in which only carbon nano-fibers were used as the conductive auxiliary agent became such high as 141 mAh/g. As a result, it was found that even the positive electrode active material was changed from LiFePO₄ (LFP) to LiCoO₂ (LCO), when only carbon nano-fibers were used as the conductive auxiliary agent, the 5 C discharging capacity became high in the same manner as Example 2. Further, in Example 3 in which LiCoO₂ (LCO) was used as the positive electrode active material of the most general lithium-ion secondary battery at the present time, since an average particle size of the coarse particle powder of the positive electrode active material was 14 μm and larger than an average particle size (1.5 μm) of the coarse particle powder of the positive electrode active material of Example 2, the volume change rate of the positive electrode was larger than that of Example 2. This is considered because gaps between the coarse particle powders of the positive electrode active material LiCoO₂ (LCO) become larger. The reason why when the volume change rate of the positive electrode of Comparative Example 5 was set to 100%, the volume change rate of the positive electrode of Example 3 decreased to 86% is considered that because the positive electrode of Example 3 did not use acetylene black (AB) having low bulk density, the volume of the positive electrode per unit volume decreased.

### Example 4

A positive electrode was prepared in the same manner as Example 1 except that Li(MnₓNi_{y}Co_{z})O₂ (herein, X, Y, and Z=⅓) was used as the positive electrode active material, this positive electrode active material was made of a mixed powder in which a coarse particle powder having an average particle size of 8 μm and a fine particle powder (fine particle powder having an average particle size of 2 μm) having an average particle size of ¼ of the average particle size of the coarse particle powder were mixed such that the fine particle powder is 50% by mass relative to 50% by mass of the coarse particle powder, and mixing ratios of carbon nano-fibers (CNF), polyvinylidene fluoride (PVDF) and the positive electrode active material (Li(MnₓNi_{y}Co_{z})O₂ (herein, X, Y, and Z=⅓)) were set to 3% by mass, 5% by mass, and 92% by mass when the electrode film (a total amount of the electrode paste excluding the organic solvent) was set to 100% by mass. The positive electrode was taken as Example 4. The porosity of the electrode film on the electrode foil was 25%.

### Comparative Example 6

A positive electrode was prepared in the same manner as Example 1 except that Li(MnₓNi_{y}Co_{z})O₂ (herein, X, Y, and Z=⅓) was used as the positive electrode active material, this positive electrode active material was made of a mixed powder in which a coarse particle powder having an average particle size of 8 μm and a fine particle powder (fine particle powder having an average particle size of 2 μm) having an average particle size of ¼ of the average particle size of the coarse particle powder were mixed such that the fine particle powder is 50% by mass relative to 50% by mass of the coarse particle powder, and mixing ratios of acetylene black (AB), carbon nano-fibers (CNF), polyvinylidene fluoride (PVDF) and the positive electrode active material (Li(MnₓNi_{y}Co_{z}O₂ (herein, X, Y, and Z=⅓)) were set to 5% by mass, 3% by mass, 5% by mass, and 87% by mass when the electrode film (a total amount of the electrode paste excluding the organic solvent) was set to 100% by mass. The positive electrode was taken as Comparative Example 6. The porosity of the electrode film on the electrode foil was 25%.

<Comparison Test 4 and Evaluation>

With the positive electrodes of Example 4 and Comparative Example 6, in the same manner as Comparison Test 1, lithium-ion secondary batteries were prepared and the 5 C discharging capacities were measured, and the volume change rates were obtained in the same manner as Comparison Test 2. These results are shown in Table 4. In order to make comparison due to the difference of the kinds of the positive electrode active materials easy, in Table 4, also data of Example 2 was described.

TABLE 4

| | Conductive | | | Positive electrode | | | | |
|---|---|---|---|---|---|---|---|---|
| | auxiliary agent | | Binder | active material | | | 5 C | Volume |
| | AB | CNF | PVDF | | Content ratio | | discharging | change |
| | (% by | (% by | (% by | | (% by | Porosity | capacity | rate |
| | mass) | mass) | mass) | Kind | mass) | (%) | (mAh/g) | (%) |
| Example 2 | 0 | 3 | 5 | LiFePO₄ | 92 | 25 | 121 | 71 |
| | | | | (LFP) | | | | |
| Example 4 | 0 | 3 | 5 | (1) | 92 | 25 | 146 | 85 |
| Comparative | 5 | 3 | 5 | (1) | 87 | 25 | 71 | 100 |
| Example 6 | | | | | | | | |

(1) Li(MnₓNi_{y}Co_{z})O₂ (X, Y, Z = ⅓)

As obvious from Table 4, while, in Comparative Example 6 in which a mixed powder of acetylene black (AB) and carbon nano-fibers was used as the conductive auxiliary agent, the 5 C discharging capacity was such low as 71 mAh/g, in Example 4 in which only carbon nano-fibers were used as the conductive auxiliary agent, the 5 C discharging capacity became such high as 146 mAh/g. As a result, it was found that even the positive electrode active material was changed from LiFePO₄ (LFP) to Li(MnₓNi_{y}Co_{z})O₂, when only carbon nano-fibers were used as the conductive auxiliary agent, the 5 C discharging capacity became high in the same manner as Example 2. Further, in Example 4 in which Li(MnₓNi_{y}Co_{z})O₂ was used as the positive electrode active material, since an average particle size of the coarse particle powder of the positive electrode active material was 8 μm and larger than an average particle size (1.5 μm) of the coarse particle powder of the positive electrode active material of Example 2, a decrease width of the volume change rate of the positive electrode was smaller than that of Example 2. This is considered because gaps between the coarse particle powders of the positive electrode active material Li(MnₓNi_{y}Co_{z})O₂ become larger. The reason why when the volume change rate of the positive electrode of Comparative Example 6 was set to 100%, the volume change rate of the positive electrode of Example 4 decreased to 85% is considered that because the positive electrode of Example 4 did not use acetylene black (AB) having low bulk density, the volume of the positive electrode per unit volume decreased.

### Example 5

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 1.5% by mass, 5% by mass, and 93.5% by mass when the electrode film (a total amount of the electrode paste excluding the organic solvent) was set to 100% by mass and the porosity of the electrode film on the electrode foil was 25%. The positive electrode was taken as Example 5.

### Example 6

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 1% by mass, 5% by mass, and 94% by mass when the electrode film (a total amount of the electrode paste excluding the organic solvent) was set to 100% by mass, and the porosity of the electrode film on the electrode foil was 25%. The positive electrode was taken as Example 6.

### Example 7

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 0.5% by mass, 5% by mass, and 94.5% by mass when the electrode film (a total amount of the electrode paste excluding the organic solvent) was set to 100% by mass, and the porosity of the electrode film on the electrode foil was 25%. The positive electrode was taken as Example 7.

### Example 8

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 0.3% by mass, 5% by mass, and 94.7% by mass when the electrode film (a total amount of the electrode paste excluding the organic solvent) was set to 100% by mass, and the porosity of the electrode film on the electrode foil was 25%. The positive electrode was taken as Example 8.

### Example 9

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 0.1% by mass, 5% by mass, and 94.9% by mass when the electrode film (a total amount of the electrode paste excluding the organic solvent) was set to 100% by mass, and the porosity of the electrode film on the electrode foil was 25%. The positive electrode was taken as Example 9.

<Comparison Test 5 and Evaluation>

With the positive electrodes of Example 2, Examples 5 to 9, and Comparative Example 3, in the same manner as Comparison Test 1, lithium-ion secondary batteries were prepared, the 5 C discharging capacities were measured, and the volume change rates were obtained in the same manner as Comparison Test 2. These results are shown in Table 5.

TABLE 5

| | Conductive | | | Positive electrode | | | |
|---|---|---|---|---|---|---|---|
| | auxiliary agent | | Binder | active material | | 5 C | Volume |
| | AB | CNF | PVDF | LiFePO₄ | | discharging | change |
| | (% by | (% by | (% by | (LFP) (% by | Porosity | capacity | rate |
| | mass) | mass) | mass) | mass) | (%) | (mAh/g) | (%) |
| Example 2 | 0 | 3 | 5 | 92 | 25 | 121 | 71 |
| Example 5 | 0 | 1.5 | 5 | 93.5 | 25 | 125 | 66 |
| Example 6 | 0 | 1 | 5 | 94 | 25 | 120 | 65 |
| Example 7 | 0 | 0.5 | 5 | 94.5 | 25 | 110 | 64 |
| Example 8 | 0 | 0.3 | 5 | 94.7 | 25 | 104 | 64 |
| Example 9 | 0 | 0.1 | 5 | 94.9 | 25 | 99 | 64 |
| Comparative | 5 | 3 | 5 | 87 | 25 | 97 | 100 |
| Example 3 | | | | | | | |

As obvious from Table 5, while, in Comparative Example 3 in which 3% by mass of carbon nano-fibers (CNF) and 5% by mass of acetylene black (AB) were added as the conductive auxiliary agent, the 5 C discharging capacity was 97 mAh/g, in Example 2 in which only 3% by mass of carbon nano-fibers (CNF) were added and acetylene black (AB) was not added as the conductive auxiliary agent, the 5 C discharging capacity became such high as 121 mAh/g. Further, as shown in Example 2 and Examples 5 to 9, it was found that when only carbon nano-fibers (CNF) were used as the conductive auxiliary agent and the carbon nano-fibers (CNF) were gradually decreased, the 5 C discharging capacity tends to gradually decrease. However, it was found that as long as an addition ratio of the carbon nano-fibers is 0.1% by mass or more, excellent discharging characteristics are exhibited. Further, when the volume change rate of the positive electrode of Comparative Example 3 was set to 100%, in Example 2 and Examples 5 to 9, the volume change rates of the positive electrodes decreased to 64 to 71%.

### Example 10

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 1% by mass, 5% by mass, and 94% by mass when the electrode film (a total amount of the electrode paste excluding the organic solvent) was set to 100% by mass and the porosity of the electrode film on the electrode foil was set to 10% by varying pressure of a press machine. The positive electrode was taken as Example 10. At this time, linear pressure of a roll press that was used was set to 3.3 ton. As the roll press, a 5 ton air hydraulic roll press having a roll diameter of 250 mm, which was manufactured by Thank Metal Co., Ltd. was used.

### Example 11

A positive electrode was prepared in the same manner as Example 11 except that the linear pressure of the roll press was changed to 2.3 ton and the porosity of the electrode film on the electrode foil was set to 15%. This positive electrode was taken as Example 11.

### Example 12

A positive electrode was prepared in the same manner as Example 11 except that the linear pressure of the roll press was changed to 1.7 ton and the porosity of the electrode film on the electrode foil was set to 20%. This positive electrode was taken as Example 12.

### Example 13

A positive electrode was prepared in the same manner as Example 11 except that the linear pressure of the roll press was changed to 0.9 ton and the porosity of the electrode film on the electrode foil was set to 29%. This positive electrode was taken as Example 13.

### Example 14

A positive electrode was prepared in the same manner as Example 11 except that the linear pressure of the roll press was changed to 0.8 ton and the porosity of the electrode film on the electrode foil was set to 30%. This positive electrode was taken as Example 14.

### Comparative Example 7

A positive electrode was prepared in the same manner as Example 11 except that the linear pressure of the roll press was changed to 4.0 ton and the porosity of the electrode film on the electrode foil was set to 8%. This positive electrode was taken as Comparative Example 7.

### Comparative Example 8

A positive electrode was prepared in the same manner as Example 11 except that the linear pressure of the roll press was changed to 0.7 ton and the porosity of the electrode film on the electrode foil was set to 31%. This positive electrode was taken as Comparative Example 8.

### Comparative Example 9

A positive electrode was prepared in the same manner as Example 11 except that the linear pressure of the roll press was changed to 0.6 ton and the porosity of the electrode film on the electrode foil was set to 32%. This positive electrode was taken as Comparative Example 9.

<Comparison Test 6 and Evaluation>

With the positive electrodes of Example 6, Examples 10 to 14, and Comparative Examples 7 to 9, in the same manner as Comparison Test 1, lithium-ion secondary batteries were prepared, and the 5 C discharging capacities were measured. These results are shown in Table 6. The linear pressure of the roll press of Example 6 was 1.2 ton.

TABLE 6

| | Conductive | | Positive electrode | | Linear | |
|---|---|---|---|---|---|---|
| | auxiliary agent | Binder | active material | | pressure | 5 C |
| | CNF | PVDF | LiFePO₄ | | of roll | discharging |
| | (% by | (% by | (LFP) (% by | Porosity | press | capacity |
| | mass) | mass) | mass) | (%) | (ton) | (mAh/g) |
| Example 6 | 1 | 5 | 94 | 25 | 1.2 | 120 |
| Example 10 | 1 | 5 | 94 | 10 | 3.3 | 114 |
| Example 11 | 1 | 5 | 94 | 15 | 2.3 | 117 |
| Example 12 | 1 | 5 | 94 | 20 | 1.7 | 120 |
| Example 13 | 1 | 5 | 94 | 29 | 0.9 | 116 |
| Example 14 | 1 | 5 | 94 | 30 | 0.8 | 109 |
| Comparative | 1 | 5 | 94 | 8 | 4.0 | 80 |
| Example 7 | | | | | | |
| Comparative | 1 | 5 | 94 | 31 | 0.7 | 72 |
| Example 8 | | | | | | |
| Comparative | 1 | 5 | 94 | 32 | 0.6 | 44 |
| Example 9 | | | | | | |

As obvious from Table 6, while, in Comparative Example 7 in which the porosity was too low such as 8%, the 5 C discharging capacity was such low as 80 mAh/g, and in Comparative Examples 8 and 9 in which the porosities were too high such as 31% and 32%, the 5 C discharging capacities were such low 72 mAh/g and 44 mAh/g, in Example 6 and Examples 10 to 14 in which the porosities were in a proper range of 10 to 30 mAh/g, the 5 C discharging capacities were such high as 109 to 120 mAh/g. From this, it was found that in the range of 10 to 30% of the porosity, excellent discharging characteristics could be obtained, and in particular, in the range where the porosity is 15 to 25%, more excellent discharging characteristics could desirably be obtained. Further, from this, it is inferred that, in the case where only carbon nano-fibers (CNF) were used as the conductive auxiliary agent, when the porosity becomes a certain threshold value or less (30% or less) by compressing the positive electrode with a press, bonding between carbon nano-fibers (CNF) is generated, an internal resistance of the positive electrode decreases, the discharging capacity of the battery increases, and a large improvement in the battery characteristics resulted.

In the case where 3 to 8% of ordinary acetylene black (AB) or Ketjen black (KB) is contained in the positive electrode, when the porosity is 30% or less, there is a tendency that a ratio at which the electrolytic solution infiltrates into the positive electrode decreases, and the discharging capacity decreases. However, like in the present invention, when only the carbon nano-fibers (CNF) were used as the conductive auxiliary agent, even when the porosity is 30% or less, excellent discharging characteristics are exhibited. The reason why is considered because although acetylene black (AB) or Ketjen black (KB) having a low bulk density infiltrates into gaps between the active materials and the electrolytic solution does not infiltrate into this portion, since the carbon nano-fibers (CNF) adhere to a surface of the active material, even when the porosity is decreased, the electrolytic solution can infiltrate between the active materials.

### Example 15

A positive electrode was prepared in the same manner as Example 1 except that mixing ratios of carbon nano-fibers (CNF), polyvinylidene fluoride (PVDF) and a positive electrode active material (LiFePO₄ (LFP)) were set to 3% by mass, 1% by mass, and 96% by mass when the electrode film (a total amount of the electrode paste excluding the organic solvent) was set to 100% by mass and the porosity of the electrode film on the electrode foil was set to 29% by varying pressure of a press machine. This positive electrode was taken as Example 15. At this time, the linear pressure of a roll press that was used was set to 1.5 ton. As the roll press, a 5 ton air hydraulic roll press having a roll diameter of 250 mm, which was manufactured by Thank Metal Co., Ltd. was used.

### Example 16

A positive electrode was prepared in the same manner as Example 15 except that mixing ratios of carbon nano-fibers (CNF), polyvinylidene fluoride (PVDF) and the positive electrode active material (LiFePO₄ (LFP)) were set to 3% by mass, 3% by mass, and 94% by mass when the electrode film (a total amount of the electrode paste excluding the organic solvent) was set to 100% by mass. This positive electrode was taken as Example 16.

### Example 17

A positive electrode was prepared in the same manner as Example 15 except that mixing ratios of carbon nano-fibers (CNF), polyvinylidene fluoride (PVDF) and the positive electrode active material (LiFePO₄ (LFP)) were set to 3% by mass, 5% by mass, and 92% by mass when the electrode film (a total amount of the electrode paste excluding the organic solvent) was set to 100% by mass. This positive electrode was taken as Example 17.

### Example 18

A positive electrode was prepared in the same manner as Example 15 except that mixing ratios of carbon nano-fibers (CNF), polyvinylidene fluoride (PVDF) and the positive electrode active material (LiFePO₄ (LFP)) were set to 3% by mass, 8% by mass, and 89% by mass when the electrode film (a total amount of the electrode paste excluding the organic solvent) was set to 100% by mass. This positive electrode was taken as Example 18.

### Comparative Example 10

A positive electrode was prepared in the same manner as Example 15 except that mixing ratios of carbon nano-fibers (CNF), polyvinylidene fluoride (PVDF) and the positive electrode active material (LiFePO₄ (LFP)) were set to 3% by mass, 0.5% by mass, and 96.5% by mass when the electrode film (a total amount of the electrode paste excluding the organic solvent) was set to 100% by mass. This positive electrode was taken as Comparative Example 10.

### Comparative Example 11

A positive electrode was prepared in the same manner as Example 15 except that mixing ratios of carbon nano-fibers (CNF), polyvinylidene fluoride (PVDF) and the positive electrode active material (LiFePO₄ (LFP)) were set to 3% by mass, 10% by mass, and 87% by mass when the electrode film (a total amount of the electrode paste excluding the organic solvent) was set to 100% by mass. This positive electrode was taken as Comparative Example 11.

<Comparison Test 7 and Evaluation>

With the positive electrodes of Examples 15 to 18, and Comparative Examples 10 and 11, in the same manner as Comparison Test 1, lithium-ion secondary batteries were prepared and the 5 C discharging capacities were measured. These results are shown in Table 7.

TABLE 7

| | | | | Positive | |
|---|---|---|---|---|---|
| | Conductive | | | electrode | |
| | auxiliary agent | | Binder | active | 5 C |
| | AB | CNF | PVDF | material | discharging |
| | (% by | (% by | (% by | LiFePO₄ (LFP) | capacity |
| | mass) | mass) | mass) | (% by mass) | (mAh/g) |
| Example 15 | 0 | 3 | 1 | 96 | 101 |
| Example 16 | 0 | 3 | 3 | 94 | 114 |
| Example 17 | 0 | 3 | 5 | 92 | 125 |
| Example 18 | 0 | 3 | 8 | 89 | 105 |
| Comparative | 0 | 3 | 0.5 | 96.5 | 72 |
| Example 10 | | | | | |
| Comparative | 0 | 3 | 10 | 87 | 88 |
| Example 11 | | | | | |

As obvious from Table 7, while, in Comparative Example 10 in which the content ratio of the binder (PVDF) was too low such as 0.5% by mass, the 5 C discharging capacity was such low as 72 mAh/g, and in Comparative Example 11 in which the content ratio of the binder (PVDF) was too high such as 10% by mass, the 5 C discharging capacity was such low as 88 mAh/g, in Examples 15 to 18 in which the content ratios of the binder (PVDF) were in a proper range of 1 to 8% by mass, the 5 C discharging capacities became such high as 101 to 125 mAh/g. From this, it was found that in the range of 1 to 8% by mass of the content ratio of the binder (PVDF), excellent discharging characteristics could be obtained, and in particular, in the range where the content ratio of the binder (PVDF) is in the range of 3 to 5% by mass, more excellent discharging characteristics could desirably be obtained.

In Comparative Example 10, it is considered that since the content ratio of the binder (PVDF) was too low, the adhesiveness between the positive electrode active materials (LFP) or adhesiveness between the electrode film and the current collector (aluminum foil) was weak, and the discharging characteristic decreased. Further, in Comparative Example 11, since the content ratio of the binder (PVDF) was too high, although the adhesiveness between the positive electrode active materials (LFP) was enhanced, since an amount of the binder (PVDF) that is an electrical insulator was too much more than an amount of the conductive auxiliary agent, the discharging characteristics were degraded.

### Example 19

A positive electrode was prepared in the same manner as Example 1 except that LiCoO₂ (LCO) was used as the positive electrode active material, this positive electrode active material was made of a mixed powder in which a coarse particle powder having an average particle size of 10 μm and a fine particle powder (fine particle powder having an average particle size of 3 μm) having an average particle size of 30% (about 1/3.3) of the average particle size of the coarse particle powder were mixed such that the fine particle powder is 50% by mass relative to 50% by mass of the coarse particle powder, and mixing ratios of carbon nano-fibers (CNF), polyvinylidene fluoride (PVDF) and the positive electrode active material (LiCoO₂ (LCO)) were set to 1.5% by mass, 1.5% by mass, and 97% by mass when the electrode film (a total amount of the electrode paste excluding the organic solvent) was set to 100% by mass. This positive electrode was taken as Example 19. The porosity of the electrode film on the electrode foil at this time was 22%. Further, the linear pressure of the roll press used was set to 1.8 ton. As the roll press, a 5 ton air hydraulic roll press having a roll diameter of 250 mm, which was manufactured by Thank Metal Co., Ltd. was used.

### Example 20

A positive electrode was prepared in the same manner as Example 19 except that LiCoO₂ (LCO) was used as the positive electrode active material, and this positive electrode active material was made of a mixed powder in which a coarse particle powder having an average particle size of 20 μm and a fine particle powder (fine particle powder having an average particle size of 2 μm) having an average particle size of 10% ( 1/10) of the average particle size of the coarse particle powder were mixed such that the fine particle powder is 50% by mass relative to 50% by mass of the coarse particle powder. This positive electrode was taken as Example 20.

### Comparative Example 12

A positive electrode was prepared in the same manner as Example 19 except that LiCoO₂ (LCO) was used as the positive electrode active material, and this positive electrode active material was made of a mixed powder in which a coarse particle powder having an average particle size of 20 μm and a fine particle powder (fine particle powder having an average particle size of 10 μm) having an average particle size of 50% (½) of the average particle size of the coarse particle powder were mixed such that the fine particle powder is 50% by mass relative to 50% by mass of the coarse particle powder. This positive electrode was taken as Comparative Example 12.

### Example 21

A positive electrode was prepared in the same manner as Example 1 except that LiFePO₄ (LFP) was used as the positive electrode active material, this positive electrode active material was made of a mixed powder in which a coarse particle powder having an average particle size of 1 μm and a fine particle powder (fine particle powder having an average particle size of 0.1 μm) having an average particle size of 10% ( 1/10) of the average particle size of the coarse particle powder were mixed such that the fine particle powder is 50% by mass relative to 50% by mass of the coarse particle powder, and mixing ratios of carbon nano-fibers (CNF), polyvinylidene fluoride (PVDF) and the positive electrode active material (LiFePO₄ (LFP)) were set to 3% by mass, 5% by mass, and 92% by mass when the electrode film (a total amount of the electrode paste excluding the organic solvent) was set to 100% by mass. This positive electrode was taken as Example 21. The porosity of the electrode film on the electrode foil at this time was 18%. Further, the linear pressure of the roll press used was set to 1.8 ton. As the roll press, a 5 ton air hydraulic roll press having a roll diameter of 250 mm, which was manufactured by Thank Metal Co., Ltd. was used.

### Example 22

A positive electrode was prepared in the same manner as Example 21 except that LiFePo₄ (LFP) was used as the positive electrode active material, and this positive electrode active material was made of a mixed powder in which a coarse particle powder having an average particle size of 1 μm and a fine particle powder (fine particle powder having an average particle size of 0.2 μm) having an average particle size of 20% (⅕) of the average particle size of the coarse particle powder were mixed such that the fine particle powder is 50% by mass relative to 50% by mass of the coarse particle powder. This positive electrode was taken as Example 22.

### Comparative Example 13

A positive electrode was prepared in the same manner as Example 21 except that LiFePo₄ (LFP) was used as the positive electrode active material, and this positive electrode active material was made of a mixed powder in which a coarse particle powder having an average particle size of 1 μm and a fine particle powder (fine particle powder having an average particle size of 0.05 μm) having an average particle size of 5% ( 1/20) of the average particle size of the coarse particle powder were mixed such that the fine particle powder is 50% by mass relative to 50% by mass of the coarse particle powder. This positive electrode was taken as Comparative Example 13.

### Example 23

A positive electrode was prepared in the same manner as Example 1 except that (Li(MnₓNi_{y}Co_{z})O₂ (X,Y,Z=⅓)) was used as the positive electrode active material, this positive electrode active material was made of a mixed powder in which a coarse particle powder having an average particle size of 5 μm and a fine particle powder (fine particle powder having an average particle size of 1 μm) having an average particle size of 20% (⅕) of the average particle size of the coarse particle powder were mixed such that the fine particle powder is 50% by mass relative to 50% by mass of the coarse particle powder, further mixing ratios of carbon nano-fibers (CNF), polyvinylidene fluoride (PVDF) and the positive electrode active material (Li(MnₓNi_{y}Co_{z})O₂ (X,Y,Z=⅓)) were set to 2% by mass, 4% by mass, and 94% by mass when the electrode film (a total amount of the electrode paste excluding the organic solvent) was set to 100% by mass. This positive electrode was taken as Example 23. The porosity of the electrode film on the electrode foil at this time was 23%. Further, the linear pressure of the roll press used was set to 1.8 ton. As the roll press, a 5 ton air hydraulic roll press having a roll diameter of 250 mm, which was manufactured by Thank Metal Co., Ltd. was used.

### Example 24

A positive electrode was prepared in the same manner as Example 23 except that (Li(MnₓNi_{y}Co_{z})O₂ (X, Y, Z=⅓)) was used as the positive electrode active material, and this positive electrode active material was made of a mixed powder in which a coarse particle powder having an average particle size of 15 μm and a fine particle powder (fine particle powder having an average particle size of 5 μm) having an average particle size of about 33% (⅓) of the average particle size of the coarse particle powder were mixed such that the fine particle powder is 50% by mass relative to 50% by mass of the coarse particle powder. This positive electrode was taken as Example 24.

### Comparative Example 14

A positive electrode was prepared in the same manner as Example 23 except that (Li(MnₓNi_{y}Co_{z})O₂ (X, Y, Z=⅓)) was used as the positive electrode active material, and this positive electrode active material was made of a mixed powder in which a coarse particle powder having an average particle size of 15 μm and a fine particle powder (fine particle powder having an average particle size of 1 μm) having an average particle size of about 7% ( 1/15) of the average particle size of the coarse particle powder were mixed such that the fine particle powder is 50% by mass relative to 50% by mass of the coarse particle powder. This positive electrode was taken as Comparative Example 14.

<Comparison Test 8 and Evaluation>

With the positive electrodes of Examples 19 to 24 and Comparative Examples 12 to 14, in the same manner as Comparison Test 1, lithium-ion secondary batteries were prepared, and the 5 C discharging capacities were measured. These results are shown in Table 8.

TABLE 8

| | | | Positive electrode active material | | | | | |
|---|---|---|---|---|---|---|---|---|
| | Conductive | | | | Average particle | | | |
| | auxiliary agent | Binder | | Content | size (μm) | | | 5 C |
| | CNF | PVDF | | ratio | Coarse | Fine | | discharging |
| | % by | % by | | % by | particle | particle | | capacity |
| | mass | mass | Kind | mass | powder A | powder B | B/A % | mAh/g |
| Example 19 | 1.5 | 1.5 | LiCoO₂ | 97 | 10 | 3 | 30 | 130 |
| | | | (LCO) | | | | | |
| Example 20 | 1.5 | 1.5 | LiCoO₂ | 97 | 20 | 2 | 10 | 126 |
| | | | (LCO) | | | | | |
| Comparative | 1.5 | 1.5 | LiCoO₂ | 97 | 20 | 10 | 50 | 95 |
| Example 12 | | | (LCO) | | | | | |
| Example 21 | 3 | 5 | LiFePO₄ | 92 | 1 | 0.1 | 10 | 119 |
| | | | (LFP) | | | | | |
| Example 22 | 3 | 5 | LiFePO₄ | 92 | 1 | 0.2 | 20 | 123 |
| | | | (LFP) | | | | | |
| Comparative | 3 | 5 | LiFePO₄ | 92 | 1 | 0.05 | 5 | 80 |
| Example 13 | | | (LFP) | | | | | |
| Example 23 | 2 | 4 | (1) | 94 | 5 | 1 | 20 | 130 |
| Example 24 | 2 | 4 | (1) | 94 | 15 | 5 | 33 | 126 |
| Comparative | 2 | 4 | (1) | 94 | 15 | 1 | 7 | 86 |
| Example 14 | | | | | | | | |

(1): Li(MnₓNi_{y}Co_{z})O₂ (X, Y, Z = ⅓)

As obvious from Table 8, in the case where LiCoO₂ (LCO) was used as the positive electrode active material, while, in Comparative Example 12 in which a ratio B/A of an average particle size B of the fine particle powder relative to an average particle size A of the coarse particle powder was too large such as 50% (½), the 5 C discharging capacity was such low as 95 mAh/g, in Examples 19 and 20 in which the ratios B/A of an average particle size B of the fine particle powder relative to an average particle size A of the coarse particle powder were in a proper range of 30% (about 1/3.3) and 10% ( 1/10), the 5 C discharging capacities became such high as 130 and 126 mAh/g. Further, in the case where LiFePO₄ (LFP) was used as the positive electrode active material, while in Comparative Example 13 in which the ratio B/A of the average particle size B of the fine particle powder relative to the average particle size A of the coarse particle powder was too small such as 5% ( 1/20), the 5 C discharging capacity was such low as 80 mAh/g, in Examples 21 and 22 in which the ratios B/A of the average particle size B of the fine particle powder relative to the average particle size A of the coarse particle powder were in a proper range of 10% ( 1/10) and 20% (⅕), the 5 C discharging capacities became such high as 119 mAh/g and 123 mAh/g. Further, in the case where (Li(MnₓNi_{y}Co_{z})O₂ (X, Y, Z=⅓)) was used as the positive electrode active material, while, in Comparative Example 14 in which the ratio B/A of the average particle size B of the fine particle powder relative to the average particle size A of the coarse particle powder was too small such as about 7% ( 1/15), the 5 C discharging capacity was such small as 86 mAh/g, in Examples 23 and 24 in which the ratios B/A of the average particle size B of the fine particle powder relative to the average particle size A of the coarse particle powder were in a proper range such as 20% (⅕) and about 33% (⅓), the 5 C discharging capacities became such high as 130 mAh/g and 126 mAh/g.

In Comparative Example 12, it is considered that while the average particle size A of the coarse particle powder of the positive electrode active material LiCoO₂ (LCO) was 20 μm, since the average particle size B of the fine particle powder was relatively large such as 10 μm, when the carbon nano-fibers (CNF) and polyvinylidene fluoride (PVDF) were mixed, excellent conductive path could not be formed, and the discharging characteristics became low. Further, in Comparative Example 13, it is considered that while the average particle size A of the coarse particle powder of the positive electrode active material LiFePO₄ (LFP) was 1 μm, since the average particle size of the fine particle powder B was too small such as 0.01 μm, aggregates of the carbon nano-fibers (CNF) and polyvinylidene fluoride (PVDF) were formed, and the discharging characteristics were degraded thereby. Further, in Comparative Example 14, while the average particle size A of the coarse particle powder of the positive electrode active material (Li(MnₓNi_{y}Co_{z})O₂ (X,Y,Z=⅓)) was 15 μm, since the average particle size B of the fine particle powder was too small such as 1 μm, aggregates of the carbon nano-fibers (CNF) and polyvinylidene fluoride (PVDF) were formed, and the discharging characteristics were degraded thereby.

### INDUSTRIAL APPLICABILITY

The lithium-ion secondary battery of the present invention can be used as a power source of various devices such as portable telephones and so on. The present international application claims a priority right based on Japanese Patent Application No. 124908 (Patent Application No. 2012-124908) and an entire content of Patent Application No. 2012-124908 is incorporated in the present international application.

1. An electrode of a lithium-ion secondary battery, which includes an electrode film that contains a conductive auxiliary agent, a binder and an active material and is formed on an electrode foil, characterized in that:
the conductive auxiliary agent is carbon nano-fibers;
the carbon nano-fibers are contained in the range of 0.1 to 3.0% by mass relative to 100% by mass of the electrode film;
when the binder uses an organic solvent as a solvent, the binder excluding the organic solvent is contained in the range of 1.0 to 8.0% by mass relative to 100% by mass of the electrode film;
the active material is contained at a remaining percentage;
the active material is made of a mixed powder of a coarse particle powder having an average particle size of 1 to 20 μm and a fine particle powder having an average particle size of ⅓ to 1/10 of the average particle size of the coarse particle powder; and
the porosity of the electrode film is 10 to 30%.

2. The electrode of a lithium-ion secondary battery according to claim 1, wherein the binder is polyvinylidene fluoride that uses an organic solvent as a solvent.

3. The electrode of a lithium-ion secondary battery according to claim 1, wherein the active material is a positive electrode active material consisting of any one of LiCoO₂, LiMn₂O₄, LiNiO₂, LiFePO₄ or Li(MnₓNi_{y}Co_{z})O₂, herein, X, Y and Z in Li(MnₓNi_{y}Co₂)O₂ satisfy a relationship of X+Y+Z=1 and satisfy a relationship of 0<X<1, 0<Y<1 and 0<Z<1.

4. The electrode of a lithium-ion secondary battery according to claim 1, wherein the active material is a negative electrode active material made of graphite.

5. A lithium-ion secondary battery that uses the electrode according to claim 1.
